(19) United States
(12) Patent Application Publication
(10) Pub. No.: US 2011/0154937 A1
(43) Pub. Date: Jun. 30, 2011

(54) ROBOT UTILIZING JOINT SEALS

(75) Inventors: CHAO-QIANG LIU, Shenzhen City (CN); JUN-HAI LIU, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu Cheng (TW)

(21) Appl. No.: 12/730,381

(22) Filed: Mar. 24, 2010

(30) Foreign Application Priority Data
Dec. 30, 2009 (CN) 200910312663.6

(51) Int. Cl. B25J 17/00; F16J 15/34

(52) U.S. Cl. 74/490.05; 277/404

(57) ABSTRACT

A robot utilizing joint seals includes a first arm, a second arm, and a first seal member. The first arm has a first resisting portion. The second arm is joined with the first arm, and the second arm has a second resisting portion corresponding to the first resisting portion of the first arm. The first seal member is positioned between the first resisting portion and the second resisting portion; and the first seal member has surfaces contacting both the first resisting portion and the second resisting portion. The first seal member is of the same size and shape as the first resisting portion and the second resisting portion.

### BACKGROUND

1. Technical Field

The present disclosure generally relates to robots, and particularly to robots with an adequate seal.

2. Description of Related Art

With developments in manufacturing technology, robots are widely applied to perform functions in environments considered hazardous or difficult for operators. Robot arms are standard elements of the robot.

A commonly used robot includes a plurality of arms joined in an arrangement to accomplish a predetermined manipulation. Motors and reducers are generally positioned at the joints of the robot arms to transfer rotation, with required size of the motors and reducers increasing according to the weight of the robot arms, with oil and power consumption of the motors and reducers increasing correspondingly. Thus, most robot arms are generally made of lighter metals to minimize the required size of the motor and reducer while conserving oil and power.

Since aluminum has a lower cost than other metals or alloys, such as magnesium, titanium, and others, and casting technology for aluminum alloy is well developed, most arms and other elements of the robot are made of aluminum alloy.

However, the arms and other elements are worn with use. It is difficult to reassemble the robot when some of the arms, motors, or reducers are repaired or replaced. Furthermore, gaps, through which the lubrication or lubricant leaks, may be formed between the resisting surfaces of the arms, motors, reducers, and other elements. Since the gaps are formed between the resisting surfaces, o-rings are unable to provide adequate seal.

Therefore, there is room for improvement within the art.

### BRIEF DESCRIPTION OF THE DRAWING

The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is an assembled, isometric view of an embodiment of a robot utilizing joint seals.

FIG. 2 is a partially exploded, isometric view of the robot utilizing joint seals of FIG. 1.

FIG. 3 is similar to FIG. 2, but viewed from another aspect.

### DETAILED DESCRIPTION

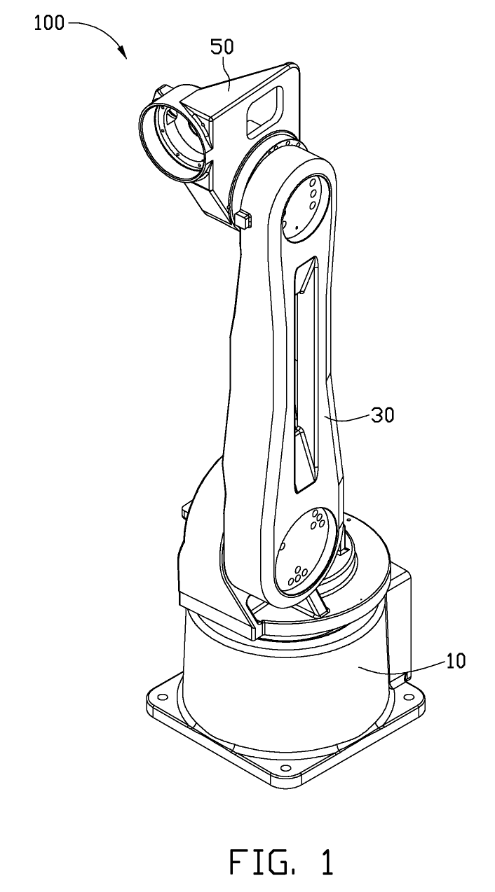

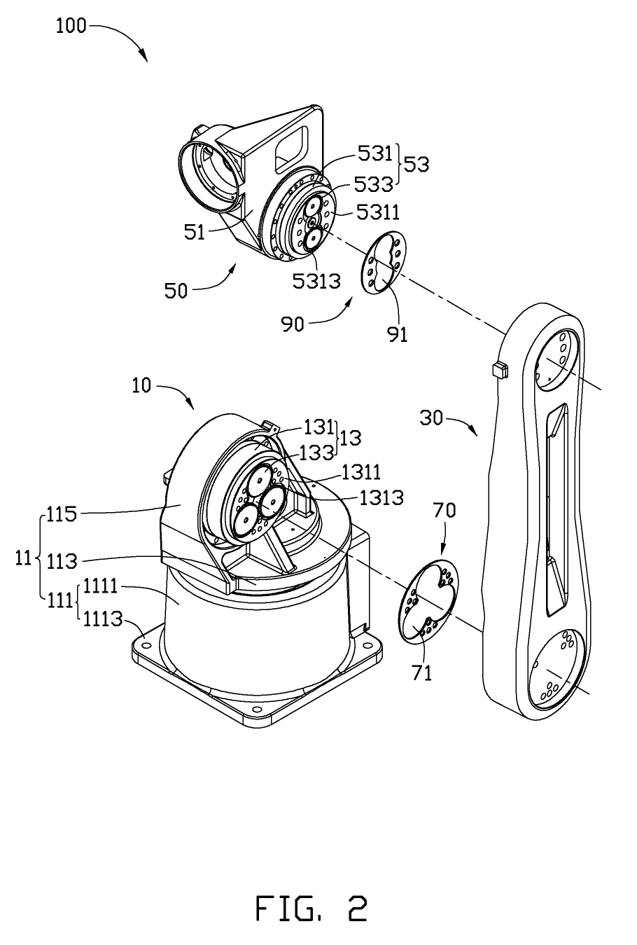

Referring to FIGS. 1 and 2, an embodiment of a robot 100 utilizing joint seals includes a first arm 10, a second arm 30, a third arm 50, a first seal member 70, and a second seal member 90. The first arm 10, the second arm 30, and the third arm 50 are rotatably joined in that order. The first seal member 70 is positioned at a joint between the second arm 30 and the first arm 10, and the second seal member 90 is positioned at a joint between the third arm 50 and the second arm 30. The first arm 10, the second arm 30, and the third arm 50 are made of aluminum alloy.

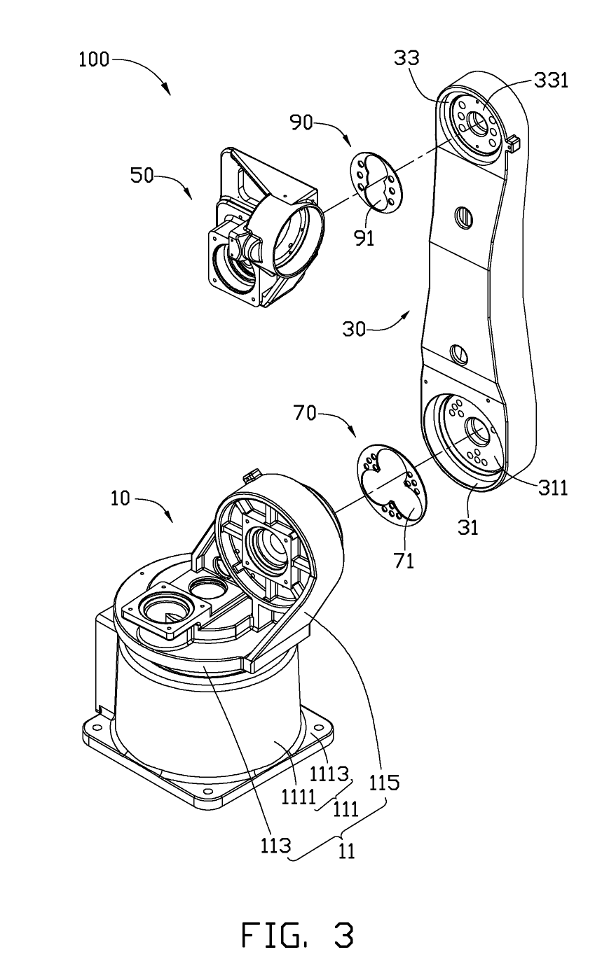

Also referring to FIG. 3, the first arm 10 includes a first main body 11 and a first reducer 13 positioned on the first main body 11.

The first main body 11 includes a base 111, a rotation member 113, and a joining member 115. The base 111 includes a receiving shield 1111 and a connecting portion 1113 formed on an end of the receiving shield 1111. Components such as cables are received in the receiving shield 1111. The connecting portion 1113 is a flange by which the first arm 10 is fixed to the ground or other equipments. The rotation member 113 is partially received in the receiving shield 1111 of the base 111, and the rotation member 113 is rotatable relative to the base 111. The joining member 115 is connected to the rotation member 113, and is capable of rotating with the rotation member 113.

The first reducer 13 is a cycloid pin wheel reducer. The first reducer 13 includes a first reducer main body 131 and a plurality of gears 133 received therein. The first reducer main body 131 forms a first resisting portion 1311 on one end thereof and defines a first receptacle 1313 and a plurality of connecting holes (not labeled) in the first resisting portion 1311. The gears 133 are received in the receptacle 1313. In the illustrated embodiment, the first reducer 13 includes three gears 133; and the first resisting portion 1311 is a circular plane surface.

In the first arm 10, one end of the first reducer 13 located away from the first resisting portion 1311 is received in the joining member 115 of the first main body 11; and the end of the first reducer 13 is connected to a motor (not shown).

The second arm 30 defines a first receiving portion 31 and a second receiving portion 33 adjacent to opposite ends thereof. The first receiving portion 31 has a first bottom wall (not labeled) forming a second resisting portion 311 corresponding to the first resisting portion 1311 of the first arm 10. The second receiving portion 33 has a second bottom wall (not labeled) forming a third resisting portion 331. In the illustrated embodiment, the second and third resisting portions 311, 331 are both circular.

The third arm 50 includes a joining member 51 and a second reducer 53. The second reducer 53 is a cycloid pin wheel reducer with one end received in the joining member 51. The second reducer 53 includes a reducer main body 531 and a plurality of gears 533 received therein. The reducer main body 531 forms a fourth resisting portion 5311 on one end thereof and defines a second receptacle 5313 and a plurality of connecting holes (not labeled) in the fourth resisting portion 5311. The gears 533 are received in the second receptacle 5313. In the illustrated embodiment, the second reducer 53 includes two gears 533; and the fourth resisting portion 5311 is a circular plane surface corresponding to the third resisting portion 331 of the second arm 30.

Fishpaper, exhibiting excellent isolation, flexibility, durability, age resistance, water resistance, and oil resistance properties, is widely used as a sealing member.

The first seal member 70 is made of a piece of fishpaper of the same size and shape as the second resisting portion 311 of the second arm 30. The first seal member 70 defines a first opening 71 of the same size and shape as the first receptacle 1313 of the first reducer 13. In the illustrated embodiment, the first seal member 70 is circular and defines a corresponding number of connecting holes (not labeled) as the first reducer 13.

The second seal member 90 is made of a piece of fishpaper of the same size and shape as the third resisting portion 331 of the second arm 30. The second seal member 90 defines a second opening 91 of the same size and shape as that of the second receptacle 5313 of the second reducer 53. In the illustrated embodiment, the second seal member 90 is also circular and defines the same number of connecting holes (not labeled) as the second reducer 53.

In the robot 100, the first seal member 70 is positioned in the first receiving portion 31 of the second arm 30 with one surface of the first seal member 70 contacting the second resisting portion 311 therein. The first reducer 13 of the first arm 10 is received in the first receiving portion 31 of the second arm 30, and the first reducer 13 resists the other surface of the first seal member 70 therein. The first seal member 70 is positioned to ensure that the first opening 71 accurately aims at the first receptacle 1313 of the first reducer 13. The first reducer 13, the first seal member 70, and the second arm 30 are fastened by fasteners, such as rivets, screws, and so on, running through the connecting holes. Thereby, the first seal member 70 is compressed by the first resisting portion 1311 and the second resisting portion 311.

The second seal member 90 is positioned in the second receiving portion 33 of the second arm 30, and one surface of the second seal member 90 contacts the third resisting portion 331 therein. The second reducer 53 of the third arm 50 is received in the second receiving portion 33 of the second arm 30, and the second reducer 53 resists the other surface of the second seal member 90 therein. The second seal member 90 is positioned to ensure that the second opening 91 lines up accurately with the second receptacle 5313 of the second reducer 53. The second reducer 53, the second seal member 90, and the second arm 30 are also fastened by the fasteners. The second seal member 90 is compressed by the third resisting portion 331 and the fourth resisting portion 5311.

In use, lubrication or lubricant is added into the first reducer 13 and the second reducer 53. As the robot 100 is operated over time, the second and third resisting portions 311, 331 of the second arm 30 may deform because of the resisting force of the first and second reducers 13, 53 and the fastening force of the fasteners. Since the fishpaper is flexible, the first seal member 70 and the second seal member 90 can continue to fill gaps, and the lubrication or lubricant is contained.

Since the size and shape of the first seal member 70 are the same as the first resisting portion 1311 of the first reducer 13 and that of the second resisting portion 311 of the second arm 30, the first seal member 70 is capable of completely filling the gap therebetween and achieving an adequate seal. The second seal member 90 is capable of completely filling the gap between the third resisting portion 331 and the fourth resisting portion 5311, and achieving an adequate seal in the same manner.

The first seal member 70 forms surface contact with the first and second resisting portions 1311, 311; and the second seal member 90 forms surface contacts with the third and fourth resisting portions 331, 5311, thereby improving the seal structure.

Fishpaper possesses qualities of durability, age resistance, water resistance, and oil resistance for ensuring that the first reducer 13 and the second reducer 53 of the robot 100 remain sealed for an extended period of time.

The first seal member 70 and the second seal member 90 define the first opening 71 and the second opening 91, respectively, such that the first and the second seal members 70, 90, would be making only minimal contact with the lubrication or lubricant, thereby exhibiting increased life-span. Similarly, amount of waste of the lubrication or lubricant is reduced.

In alternative embodiments, the first and the second seal members 70, 90 may be made from material such as rubber, plastic, resin, and others. The robot 100 may instead merely include two arms such as the first and second arms 10, 30 or the second and third arms 30, 50 joined together.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A robot utilizing joint seals, comprising:
a first arm comprising a first resisting portion;
a second arm joined with the first arm, and the second arm comprising a second resisting portion corresponding to the first resisting portion of the first arm; and
a first seal member;
wherein the first seal member is positioned between the first resisting portion and the second resisting portion, and the first seal member comprises opposite surfaces contacting both the first resisting portion and the second resisting portion, wherein the first seal member is of the same size and shape as the first resisting portion and the second resisting portion.

2. The robot utilizing joint seals of claim 1, wherein the first seal member is compressed by the first resisting portion and the second resisting portion.

3. The robot utilizing joint seals of claim 1, wherein the first arm comprises a first reducer, one end of the first reducer forms the first resisting portion, wherein the first seal member is positioned between the first reducer and the second arm.

4. The robot utilizing joint seals of claim 3, wherein the first reducer is a cycloid pin wheel reducer defining a first receptacle in the first resisting portion, and the first seal member defines a first opening of the same size and shape as the first receptacle.

5. The robot utilizing joint seals of claim 4, wherein the first seal member is made of fishpaper.

6. The robot utilizing joint seals of claim 3, wherein the second arm defines a first receiving portion, and a bottom wall of the first receiving portion forms the second resisting portion, and one end of the first reducer of the first arm is received in the first receiving portion and resists the second resisting portion.

7. The robot utilizing joint seals of claim 6, further comprising a third arm rotatably joined with the second arm and a second seal member positioned between the third arm and the second arm.

8. The robot utilizing joint seals of claim 7, wherein the second arm further comprises a second receiving portion, and a bottom wall of the second receiving portion forms a third resisting portion, the third arm comprising a fourth resisting portion corresponding to the third resisting portion.

9. The robot utilizing joint seals of claim 8, wherein the third arm comprises a second reducer, one end of the second reducer forms the fourth resisting portion, wherein the second seal member is positioned between the second reducer and the second arm.

10. The robot utilizing joint seals of claim 9, wherein the second reducer is a cycloid pin wheel reducer defining a second receptacle in the fourth resisting portion, and the second seal member defines a second opening of the same size and shape as the second receptacle.

11. The robot utilizing joint seals of claim 10, wherein the fourth resisting portion of the second reducer of the third arm is received in the second receiving portion and resists the third resisting portion of the second arm.

12. The robot utilizing joint seals of claim 7, wherein the second seal member is made of fishpaper.

13. A robot utilizing joint seals, comprising:
at least two arms rotatably joined together, each arm comprising at least one resisting portion; and
at least one seal member, the seal member positioned between two resisting portions resisting each other;
wherein each of the at least one seal member is of the same size and shape as the corresponding resisting portion, and the opposite surfaces of each of the at least one seal member contact the resisting portions, respectively.

14. The robot utilizing joint seals of claim 13, wherein the at least one seal member is compressed by the resisting portions of the at least two arms.

15. The robot utilizing joint seals of claim 13, wherein one of the arms comprises a reducer, one end of the reducer forms a resisting portion, and the seal member is positioned between the reducer and another arm.

16. The robot utilizing joint seals of claim 15, wherein the arm without the reducer defines at least one receiving portion with a bottom wall forming another resisting portion, and the reducer is received in the receiving portion and resists the bottom wall of the receiving portion.

17. The robot utilizing joint seals of claim 15, wherein the reducer defines a receptacle in the resisting portion, and the seal member defines an opening of the same size and shape as the receptacle.

18. The robot utilizing joint seals of claim 13, wherein the robot comprises three arms rotatably joined in order, and each of two of the arms comprises a reducer.

19. The robot utilizing joint seals of claim 13, wherein the arms are made of aluminum alloy.
